(19) United States
(12) Patent Application Publication
(10) Pub. No.: US 2014/0207453 A1
(43) Pub. Date: Jul. 24, 2014

(54) METHOD AND APPARATUS FOR EDITING VOICE RECOGNITION RESULTS IN PORTABLE DEVICE

(71) Applicant: ELECTRONICS AND TELECOMMUNICATIONS RESEARCH INSTITUTE, (US)

(72) Inventors: Jong Hun SHIN, Daejeon (KR); Chang Hyun KIM, Daejeon (KR); SEONG IL YANG, Daejeon (KR); Young- Ae SEO, Daejeon (KR); Jinxia HUANG, Daejeon (KR); Oh Woog KWON, Daejeon (KR); Seung-Hoon NA, Daejeon (KR); Yoon-Hyung ROH, Daejeon (KR); Ki Young LEE, Daejeon (KR); Sang Keun JUNG, Daejeon (KR); Sung Kwon CHOI, Daejeon (KR); Yun JIN, Daejeon (KR); Eun Jin PARK, Daejeon (KR); Young Kil KIM, Daejeon (KR); Sang Kyu PARK, Daejeon (KR)

(73) Assignee: ELECTRONICS AND TELECOMMUNICATIONS RESEARCH INSTITUTE, Daejeon (KR)

(21) Appl. No.: 13/872,382

(22) Filed: Apr. 29, 2013

(30) Foreign Application Priority Data
Jan. 22, 2013 (KR) 10-2013-0006850

(51) Int. Cl. G06F 17/24; G06F 3/041; G10L 15/26

(52) U.S. Cl. CPC G06F 17/24; G10L 15/26; G06F 3/041
USPC 704/235

(57) ABSTRACT

Disclosed is a method of editing voice recognition results in a portable device. The method includes a process of converting the voice recognition results into text and displaying the text in a touch panel, a process of recognizing a touch interaction in the touch panel, a process of analyzing an intent of execution of the recognized touch interaction, and a process of editing contents of the text based on the analyzed intent of execution.

### RELATED APPLICATIONS(S)

This application claims the benefit of Korean Patent Application No. 10-2013-0006850, filed on Jan. 22, 2013, which is hereby incorporated by references as if fully set forth herein.

### FIELD OF THE INVENTION

The present invention relates to a scheme for editing voice recognition results and, more particularly, to a method and apparatus for editing voice recognition results in a portable device, which are suitable for editing text, input through a microphone and converted into text and displayed through a touch panel, using a touch interaction.

### BACKGROUND OF THE INVENTION

The prior art that is the background of the present invention is based on a touch-based handheld device (or portable device) configured to interact with a user who directly touches the screen of the touch-based handheld device and a voice recognition system configured to convert voice, spoken by the user through the microphone, into text.

That is, a user transfers his/her voice to a handheld device using a touch-based handheld device in order to obtain desired results. The handheld device recognizes the received voice and outputs a text stream (text), that is, the final results of voice recognition, on its screen so that the user can take appropriate action.

In a conventional method, the final output (text) output by a corresponding handheld device must be directly modified through a common interface provided by a common touch-based handheld device.

The existing interface is problematic in that great inconvenience occurs when modifying errors inherent in voice recognition results because it uses a method of modifying a Short Message Service (SMS) message or a memo in modifying the final output. This inconvenience commonly occurs in a touch-based handheld device, in which the region to be modified is directly designated by touching a screen and voice recognition results are modified using given common input means.

For example, the specific error characteristics inherent in voice recognition results include an error in spacing words, the case where a syllable not intended by a user is erroneously added, the case where a syllable intended by a user is not recognized, and a case where the position of syllables is output contrary to a user's intention in the case of a voice recognition system based on a language model.

In particular, a voice recognition system based on a language model can have a problem in that results that do not correctly reflect a user's intention are output because of errors in recognition and the shortage of data in a language model embedded in the voice recognition system.

### SUMMARY OF THE INVENTION

In view of the above, the present invention provides an interface in which a user can easily edit (modify) the results (text) of a voice recognition system in a touch-based portable device and a new scheme for obtaining desired results using a smaller number of touches and behaviors through an editing interface into which specific error characteristics commonly occurring in a voice recognition system are incorporated.

In accordance with an aspect of the present invention, there is provided a method for editing voice recognition results in a portable device, including a process of converting the voice recognition results into text and displaying the text in a touch panel, a process of recognizing a touch interaction in the touch panel, a process of analyzing an intent of execution of the recognized touch interaction, and a process of editing the contents of the text based on the analyzed intent of execution.

In the present invention, the editing of the contents of the text may include any one of the merger of syllables, the separation of syllables, the addition of new words, the removal of a designated syllable, the change of the position of syllables, and the substitution or modification of syllable contents.

In the present invention, the merger of syllables may be executed through an interaction in which two syllables to be merged are touched by different fingers and a first touch of the two touches is dragged to a second touch of the two touches. The region in which the two syllables are displayed may include visually recognizable information indicative of the execution of the merger.

In the present invention, the merger of syllables is executed through an interaction in which two syllables to be merged are touched by different fingers and dragged. The region in which the two syllables are displayed may include visually recognizable information indicative of the execution of the merger.

In the present invention, the separation of syllables is executed through an interaction in which a target syllable to be separated is touched by a finger, the direction in which the target syllable will be separated is touched by another finger, and both fingers are dragged in that direction. The region in which the target syllable is displayed may include visually recognizable information indicative of the execution of the separation.

In the present invention, the addition of new words is executed by a process of designating the position into which new words will be inserted by touching a predetermined syllable addition region within the touch panel using a finger, a process of displaying a screen keyboard for entering the new words in a specific region of the touch panel when the insertion position is designated, and a process of adding the new words entered through the screen keyboard at the insertion position.

In the present invention, the region in which the insertion position is displayed may include visually recognizable information indicative of the execution of the addition.

In the present invention, the removal of a designated syllable is executed through an interaction in which a target syllable to be removed is touched by a finger and the touched finger is dragged to the top or bottom of the touch panel. The region in which the touched target syllable is displayed may include visually recognizable information indicative of the execution of the removal.

In the present invention, the change of the position of syllables is executed through an interaction in which a target syllable whose sequence will be changed is touched by a finger and the touched finger is dragged to a desired position. The touched target syllable may be moved to the dragged position.

In the present invention, the substitution or modification of syllable contents is executed through a process of designating a target syllable by a double touch or a touch using a relatively long finger, a process of displaying a screen keyboard for substituting or modifying the target syllable in a specific region of the touch panel when designating the target syllable, and a process of substituting or modifying the target syllable in response to the input through the screen keyboard. The region in which the target syllable is displayed may include visually recognizable information indicative of the execution of the substitution or modification.

In accordance with another aspect of the present invention, there is provided an apparatus for editing voice recognition results in a portable device, including a text generation block for recognizing voice received through a microphone and converting the voice into text, a display execution block for displaying the converted text in the touch panel of a portable device, an input analysis block for recognizing a touch interaction in the touch panel and analyzing the intent of execution of the recognized touch interaction, and a text editing block for editing the contents of the text displayed in the touch panel based on the analyzed intent of execution.

In the present invention, the text editing block may include a syllable merger processor for merging two syllables through an interaction in which the two syllables are touched by respective fingers and dragged; a syllable separation processor for separating a target syllable through an interaction in which the target syllable is touched by a finger, the direction in which the target syllable will be separated is touched by another finger, and the two fingers are dragged to the direction; a new syllable addition processor for touching a predetermined syllable addition region within the touch panel, displaying a screen keyboard for entering new words in a specific region of the touch panel when the position into which the new words will be inserted is designated, and adding the new words entered through the screen keyboard at the insertion position; a designated syllable removal processor for removing a target syllable through an interaction in which the target syllable is touched by a finger and the touched finger is dragged to the top or bottom of the touch panel; a syllable sequence change processor for changing the sequence or position of a target syllable to a changed sequence or position through an interaction in which the target syllable is touched by a finger and the touched target syllable is dragged to the changed position; and a syllable contents substitution or modification processor for displaying the screen keyboard for substituting or modifying a target syllable when the target syllable is designated by a double touch or a touch using a relatively long finger in a specific region of the touch panel and the target syllable is substituted or modified in response to the input through the screen keyboard.

In the present invention, the display execution block may display visually recognizable information indicative of the execution of editing in a target syllable or a region peripheral to the target syllable. The visually recognizable information may include at least one of a change of color, the display of a sign, and the display of a symbol for the target syllable or the region peripheral to the target syllable.

### BRIEF DESCRIPTION OF THE DRAWINGS

The above and other objects and features of the present invention will become apparent from the following description of embodiments given in conjunction with the accompanying drawings, in which:

FIG. 1 is a block diagram of an apparatus for editing voice recognition results in a portable device in accordance with an embodiment of the present invention;

FIGS. 2a and 2b are a flowchart illustrating major processes of editing voice recognition results in a portable device in accordance with an embodiment of the present invention;

FIGS. 3a and 3b are exemplary diagrams of a syllable merger screen for illustrating a process of merging syllables in accordance with the present invention;

FIGS. 4a and 4b are exemplary diagrams of a syllable separation screen for illustrating a process of separating syllables in accordance with the present invention;

FIGS. 5a and 5b are exemplary diagrams of a syllable addition screen for illustrating a process of adding new words in accordance with the present invention;

FIGS. 6a and 6b are exemplary diagrams of a syllable removal screen for illustrating a process of removing designated syllables in accordance with the present invention;

FIGS. 7a and 7b are exemplary diagrams of a syllable sequence change screen for illustrating a process of changing the position of syllables in accordance with the present invention; and

FIGS. 8a and 8b are exemplary diagrams of a syllable contents substitution or modification screen for illustrating the process of substituting or modifying the contents of syllables in accordance with the present invention.

### DETAILED DESCRIPTION OF THE EMBODIMENTS

Hereinafter, embodiments of the present invention will be described in detail with reference to the accompanying drawings so that they can be readily implemented by those skilled in the art.

First, the merits and characteristics of the present invention and the methods for achieving the merits and characteristics thereof will become more apparent from the following embodiments taken in conjunction with the accompanying drawings. However, the present invention is not limited to the disclosed embodiments, but may be implemented in various ways. The embodiments are provided to complete the disclosure of the present invention and to enable a person having ordinary skill in the art to understand the scope of the present invention. The present invention is defined by the claims.

In describing the embodiments of the present invention, a detailed description of known functions or constructions related to the present invention will be omitted if it is deemed that such description would make the gist of the present invention unnecessarily vague. Furthermore, terms to be described later are defined by taking the functions of embodiments of the present invention into consideration, and may be different according to the operator's intention or usage. Accordingly, the terms should be defined based on the overall contents of the specification.

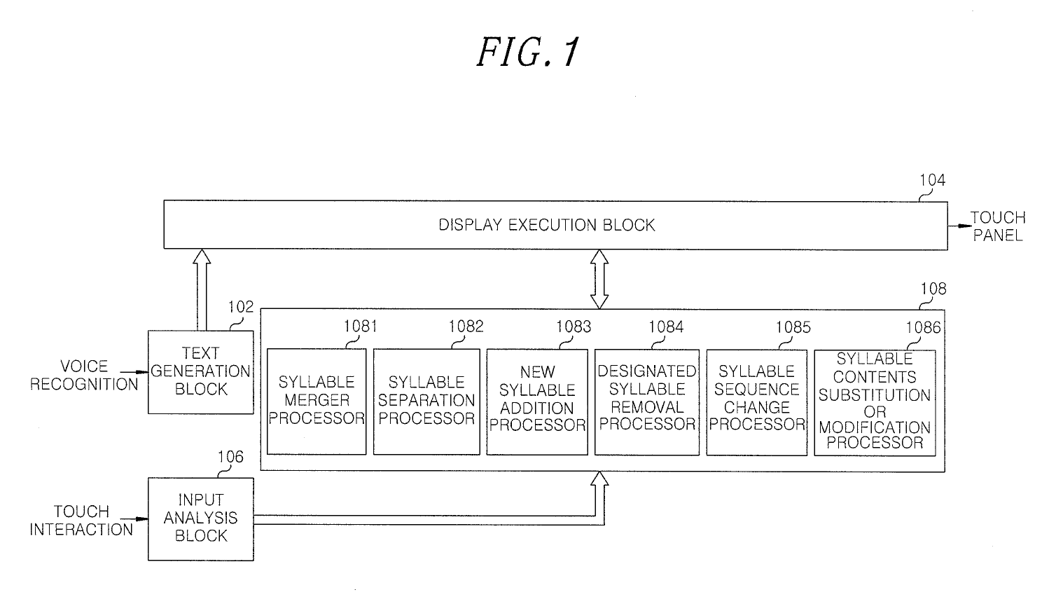

FIG. 1 is a block diagram of an apparatus for editing voice recognition results in a portable device in accordance with an embodiment of the present invention. The apparatus for editing voice recognition results can include a text generation block 102, a display execution block 104, an input analysis block 106, and a text editing block 108. The text editing block 108 can include a syllable merger processor 1081, a syllable separation processor 1082, a new syllable addition processor 1083, a designated syllable removal processor 1084, a syllable sequence change processor 1085 and a syllable contents substitution or modification processor 1086.

The apparatus for editing voice recognition results in accordance with the present invention can be fabricated in the form of an automatic interpretation application (App) and installed in (loaded onto) a portable device (or mobile terminal) in such a way as to be deleted. Such a portable device can be, for example, a mobile phone, a smart phone, a smart pad, a note pad, or a tablet PC.

Referring to FIG. 1, the text generation block 102 can provide a function of recognizing voice received through the microphone of a portable device (not shown), converting the voice into text (i.e., voice recognition results), and sending the converted voice recognition results to the display execution block 104.

The display execution block 104 can include, for example, a data driver and a scan driver, and can provide a function of displaying text received from the text generation block 102 in a touch panel (or a touch screen) (not shown).

Furthermore, the input analysis block 106 can provide a function of recognizing a touch interaction received from the touch panel (not shown) in response to a user manipulation (e.g. a touch using a finger) and analyzing the intent of execution of the recognized touch interaction.

Here, the intent of execution obtained as a result of the analysis can include, for example, the merger of syllables, the separation of syllables, the addition of new words, the removal of a designated syllable, a change in the position of syllables, and the substitution or modification of syllable contents for the voice recognition results.

That is, if the touch interaction is interpreted to mean the intent to execute a syllable merger, the input analysis block 106 generates a corresponding syllable merger instruction and transmits the syllable merger instruction to the syllable merger processor 1081. For example, when an interaction in which one of two syllables to be merged is touched by one finger, the other of the two syllables is touched by the other finger on the left or right, and one touch is dragged (i.e., a one-way drag) to the other touch or the two touches are simultaneously dragged (i.e., a dual drag) so that the two touches converge into one place is received, the input analysis block 106 interprets the received interaction as the intent of execution of a syllable merger and transmits corresponding touch interaction signals to the syllable merger processor 1081.

In response to the interaction signal generated by touching and dragging (i.e., a common drag or dual drag) the two syllables using the two fingers, the syllable merger processor 1081 for editing the contents of text being displayed in the touch panel in response to the analyzed intent of execution performs control for merging the two syllables to be merged. As a result, the display execution block 104 executes the merger display of the two syllables touched by the two fingers. This method is an editing method performed by a user when a sentence has an error in spacing words in voice recognition results (text).

Here, the display execution block 104 can display visually recognizable information for making the user aware of the execution of the merger and display in the two syllables being edited or regions peripheral thereto. The visually recognizable information can be at least one of, for example, a change of color, the display of a sign, and the display of a symbol for the two syllables or the regions peripheral thereto.

Furthermore, if the touch interaction is interpreted as the intent to execute syllable separation, the input analysis block 106 generates a corresponding syllable separation instruction and transmits the syllable separation instruction to the syllable separation processor 1082. For example, when an interaction in which a target syllable to be separated is touched by one finger, the direction (e.g., left or right) in which the target syllable will be moved is touched by the other finger, and the two fingers are dragged to the corresponding direction is received, the input analysis block 106 analyzes the interaction as the intent to execute syllable separation and transmits corresponding touch interaction signals to the syllable separation processor 1082.

In response to the corresponding touch interaction signals, the syllable separation processor 1082 performs control for separating the target syllables. As a result, the display execution block 104 separates the target syllables touched by the finger. This method is an editing method performed by a user when a sentence having an error in spacing words appears in voice recognition results (text).

Here, the display execution block 104 can display visually recognizable information for making the user aware of the execution of the separation and display in the target syllable being edited or a region peripheral thereto. The visually recognizable information can be at least one of, for example, a change of color, the display of a sign, and the display of a symbol for the target syllable or the region peripheral thereto.

Furthermore, if the touch interaction is interpreted as the intent to execute the addition of new words, the input analysis block 106 generates a corresponding new syllable addition instruction and transmits the new syllable addition instruction to the new syllable addition processor 1083. For example, when the position into which a target syllable will be inserted is designated by touching a predetermined syllable addition region within the touch panel, the input analysis block 106 analyzes the touch as the intent to add the target syllable and transmits corresponding touch interaction signals to the new syllable addition processor 1083.

In response to the corresponding touch interaction signals, the new syllable addition processor 1083 instructs the display execution block 104 to display a screen keyboard. In response to the instruction, the display execution block 104 displays the screen keyboard in the touch panel, adds the target syllable entered through the screen keyboard at the insertion position, and displays the added syllable. This method is an editing method performed by a user when a syllable intended by the user is not included in voice recognition results (text).

Here, the display execution block 104 can display visually recognizable information for making the user aware of the execution of the addition of new words at the insertion position or a region peripheral thereto. The visually recognizable information can be at least one of, for example, a change of color, the display of a sign, and the display of a symbol at the insertion position or the region peripheral thereto.

Meanwhile, when a touch interaction for adding new words is generated, the display execution block 104 provides (or displays) a candidate suggestion window, including a plurality of candidate phrases having different syllable arrangements, to (or in) the touch panel in response to a control instruction from the new syllable addition processor 1083. Accordingly, the user can select any one of the plurality of candidate phrases within the candidate suggestion window and add the new words to the selected phrase. As a result, users can add new syllables more rapidly. Next, when a user touches another region of the touch panel, the candidate suggestion window disappears from the touch panel, and the screen returns to the basic screen of the touch panel in which modification (i.e., the addition of new words) can be performed.

Furthermore, if the touch interaction is interpreted as the intent to remove a syllable, the input analysis block 106 generates a syllable removal instruction and transmits the syllable removal instruction to the designated syllable removal processor 1084. For example, when an interaction in which a target syllable to be removed is touched by a finger and the touched finger is dragged to the top or bottom of the touch panel at high speed is received, the input analysis block 106 analyzes the touch and drag as the intent to execute the removal of the target syllable and transmits corresponding touch interaction signals to the designated syllable removal processor 1084.

In response to the corresponding touch interaction signals, the designated syllable removal processor 1084 performs control for removing the target syllable. As a result, the display execution block 104 removes (or deletes) the target syllable touched by the finger. This method is an editing method performed by a user when a syllable not wanted by a user in voice recognition results (text) is removed from a sentence.

Here, the display execution block 104 can display visually recognizable information for making the user aware of the execution of the removal of the syllable in the target syllable being edited or a region peripheral thereto. The visually recognizable information can be at least one of, for example, a change of color, the display of a sign, and the display of a symbol at the target syllable or the region peripheral thereto.

Furthermore, if the touch interaction is interpreted as the intent to execute a change in the position of syllables, the input analysis block 106 generates a corresponding syllable sequence change instruction and transmits the syllable sequence change instruction to the syllable sequence change processor 1085. For example, when an interaction in which a target syllable whose position will be changed is touched by a finger and the touched finger is dragged to a desired destination position (e.g., left or right) at high speed is received, the input analysis block 106 analyzes the touch and drag as the intent to change the position of the target syllable and transmits corresponding touch interaction signals to the syllable sequence change processor 1085.

In response to the corresponding touch interaction signals, the syllable sequence change processor 1085 performs control for changing the sequence (or position) of the target syllable. As a result, the display execution block 104 changes the position (or sequence) of the target syllable touched by the finger. This method is an editing method performed by a user when the position of syllables in voice recognition results (text) is displayed in a form not intended by the user. Here, the touched target syllable can be moved in the direction in which the touched target syllable is dragged by the finger.

Here, the display execution block 104 can display visually recognizable information for making the user aware of the execution of a change in the position of the target syllable in the target syllable or a region peripheral thereto. The visually recognizable information can be at least one of, for example, a change of color, the display of a sign, and the display of a symbol for the target syllable or the region peripheral thereto.

Meanwhile, when a touch interaction for changing the position of syllables is generated, the display execution block 104 provides (or displays) a candidate suggestion window, including a plurality of candidate phrases having different syllable arrangements, to (or in) the touch panel in response to a control instruction from the syllable sequence change processor 1085. Accordingly, the user can select any one of the plurality of candidate phrases within the candidate suggestion window and change the position of syllables in the selected sentence. In this case, users can change the position of syllables more rapidly. Next, when the user touches another region of the touch panel, the candidate suggestion window disappears from the touch panel, and a screen returns to the basic screen of the touch screen in which modification (i.e., a change in the position of syllables) can be performed.

Furthermore, if the touch interaction is interpreted as the intent to execute the substitution or modification of syllable contents, the input analysis block 106 generates a corresponding syllable contents substitution or modification instruction and transmits the syllable contents substitution or modification instruction to the syllable contents substitution and modification processor 1086. For example, when a target syllable is designated by a double touch or a touch using a relatively long finger, the input analysis block 106 analyzes the a double touch or the touch using a relatively long finger as the intent to substitute or modify the contents of the target syllable and transmits corresponding touch interaction signals to the syllable contents substitution or modification processor 1086.

In response to the corresponding touch interaction signals, the new syllable addition processor 1083 instructs the display execution block 104 to display the screen keyboard. In response to the instruction, the display execution block 104 displays the screen keyboard in the touch panel and substitutes or modifies the target syllable in response to the input through the screen keyboard. This method is an editing method performed by a user when a typographical error or an error resulting from erroneous recognition appears in a sentence in voice recognition results (text).

Here, the display execution block 104 can display visually recognizable information for making the user aware of the substitution or modification of the contents of the target syllable in the target syllable being edited or a region peripheral thereto. The visually recognizable information can be at least one of, for example, a change of color, the display of a sign, and the display of a symbol at the target syllable or the region peripheral thereto.

Meanwhile, when a touch interaction for substituting or modifying the contents of a target syllable is generated, the display execution block 104 provides (or displays) a candidate suggestion window, including a plurality of candidate phrases having different syllable arrangements, to (or in) the touch panel in response to a control instruction from the syllable contents substitution or modification processor 1086. Accordingly, the user can select any one of the plurality of candidate phrases within the candidate suggestion window and substitute or modify the contents of the target syllable in the selected phrase. As a result, users can substitute or modify the contents of syllables more rapidly. Next, when the user touches another region of the touch panel, the candidate suggestion window disappears from the touch panel and a screen returns to the basic screen of the touch panel in which modification (i.e., the substitution or modification of syllable contents) can be performed.

A series of processes for providing an editing service for voice recognition results to a user who uses a portable device using the apparatus for editing voice recognition results in accordance with the present invention are described in detail below.

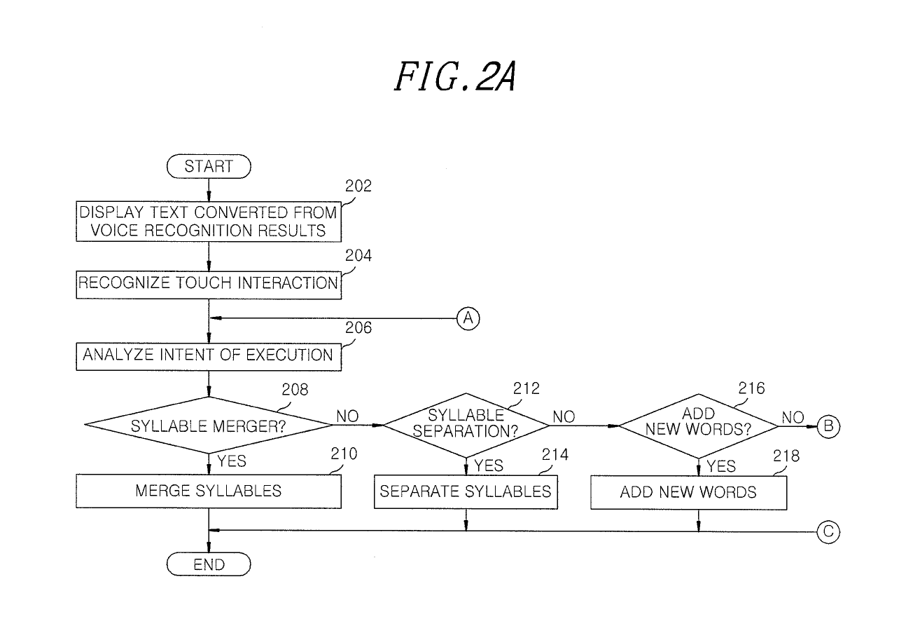

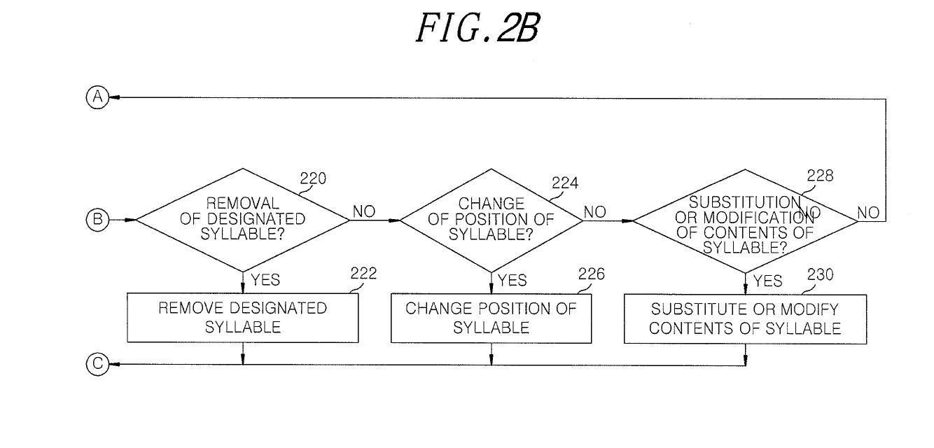

FIGS. 2a and 2b are a flowchart illustrating major processes of editing voice recognition results in a portable device in accordance with an embodiment of the present invention.

Referring to FIGS. 2a and 2b, the text generation block 102 recognizes voice received through the microphone of the portable device, converts the voice into text (i.e., voice recognition results), and sends the converted voice recognition results to the display execution block 104. Accordingly, the touch panel (or touch screen) displays the text (i.e., voice recognition results at step 202.

Next, the input analysis block 106 recognizes a touch interaction according to a tag by which a touch manipulation will be performed by the user at step 204 and analyzes the intent of execution of the recognized touch interaction at step 206. The intent of execution obtained as a result of the analysis can be any one of, for example, the merger of syllables, the separation of syllables, the addition of new words, the removal of a designated syllable, a change in the position of syllables, and the substitution or modification of syllable contents for the voice recognition results.

At step 208, the input analysis block 106 checks whether or not the received touch interaction corresponds to a touch for a syllable merger. If, as a result of the check, it is confirmed that the received touch interaction corresponds to a touch for a syllable merger, for example, if the received touch interaction is a syllable merger interaction in which one of two syllables to be merged is touched by one finger, the other of the two syllables is touched by the other finger on the left or right, and one touch is dragged (i.e., a one-way drag) to the other touch or the two touches are simultaneously dragged (i.e., a dual drag) so that the two touches converge into one place, the syllable merger processor 1081 performs control for merging the two syllables in response to corresponding touch interaction signals from the input analysis block 106. Accordingly, the display execution block 104 merges the two syllables touched by the two fingers and displays the merged syllable at step 210.

Here, the display execution block 104 can display visually recognizable information for making the user aware of the execution of the merger and display in the two syllables being edited or regions peripheral thereto. The visually recognizable information can be at least one of, for example, a change of color, the display of a sign, and the display of a symbol for the two syllables or the regions peripheral thereto. The user can complete the syllable merger task by releasing the touches of both fingers from the screen.

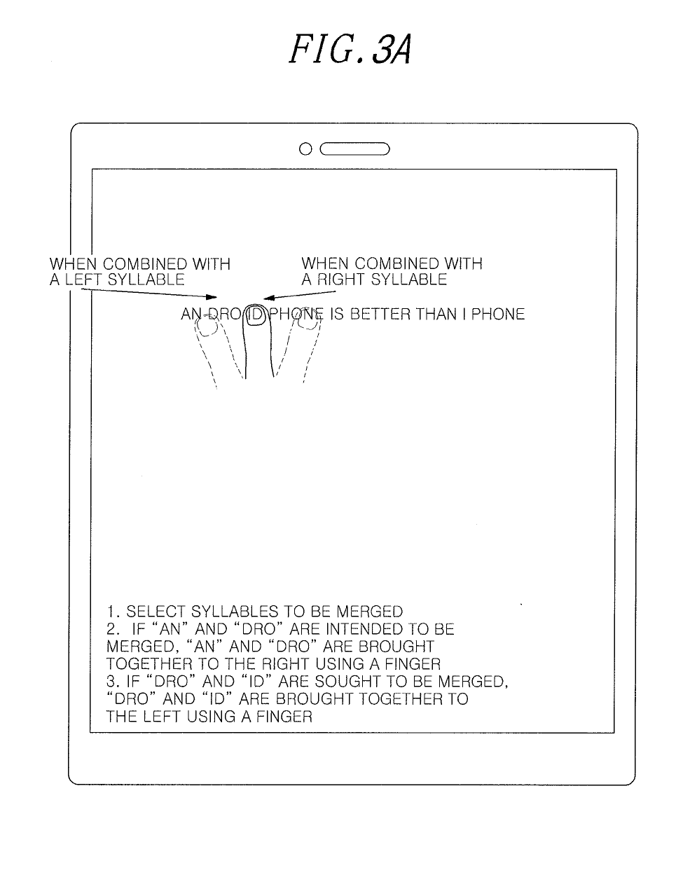

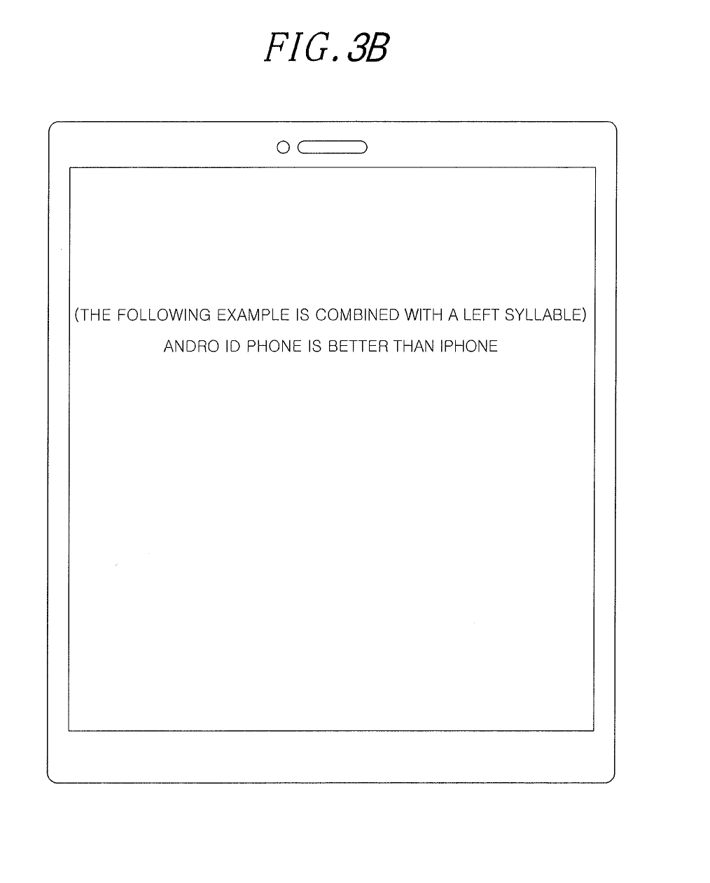

FIGS. 3a and 3b are exemplary diagrams of a syllable merger screen for illustrating the process of merging syllables in accordance with the present invention. The exemplary diagrams show that target syllables having an error in spacing words are merged through the syllable merger interaction in response to touches by two fingers in accordance with the present invention.

At step 212, the input analysis block 106 checks whether or not the received touch interaction is a touch for the separation of syllables. If, as a result of the check, it is confirmed that the received touch interaction corresponds to a touch for the separation of syllables, for example, if the received touch interaction is a syllable separation interaction in which a target syllable to be separated is touched by one finger, the direction (e.g., left or right) in which the target syllable will be moved is touched by the other finger, and the two fingers are dragged in the corresponding direction, the syllable separation processor 1082 performs control for separating the target syllable in response to corresponding touch interaction signals from the input analysis block 106. Accordingly, the display execution block 104 separates the target syllable touched by the finger and displays the separated syllable at step 214.

Here, the display execution block 104 can display visually recognizable information for making the user aware of the execution of the separation and display in the target syllable being edited or a region peripheral thereto. The visually recognizable information can be at least one of, for example, a change of color, the display of a sign, and the display of a symbol for the target syllable or the region peripheral thereto. The user can complete the syllable merger task by releasing the touches of both fingers from the screen.

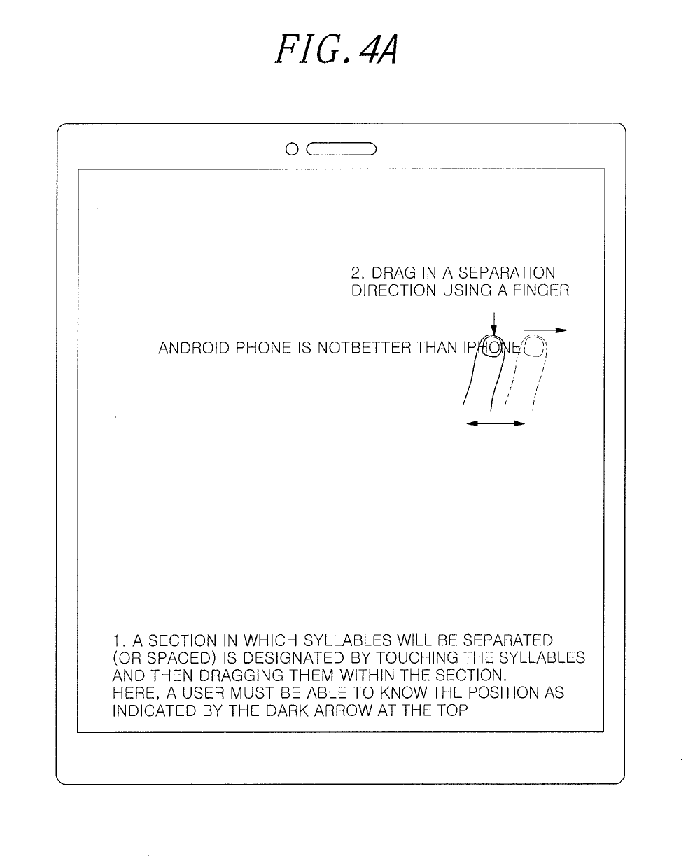

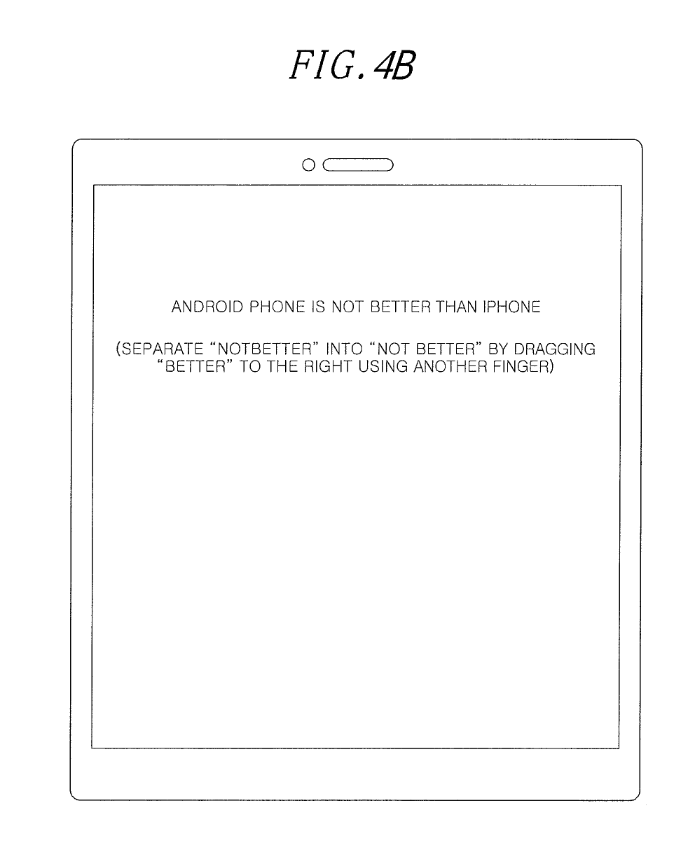

FIGS. 4a and 4b are exemplary diagrams of a syllable separation screen for illustrating the process of separating syllables in accordance with the present invention. The exemplary diagrams show that a target syllable having an error in spacing words is separated through the syllable separation interaction in response to touches by fingers in accordance with the present invention.

At step 216, the input analysis block 106 checks whether or not the received touch interaction corresponds to a touch for adding new words. If, as a result of the check, it is confirmed that the received touch interaction corresponds to a touch for adding new words, for example, if the position into which new words will be inserted is designated by touching a predetermined syllable addition region within the touch panel, the screen keyboard is displayed in the touch panel, and the new words are entered in response to the touch manipulation of a user, the new syllable addition processor 1083 performs control for adding the new words in response to corresponding touch interaction signals from the input analysis block 106. Accordingly, the display execution block 104 adds the new words entered through the screen keyboard at the insertion position and displays the added syllable at step 218.

Here, the display execution block 104 can display visually recognizable information for making the user aware of the execution of the addition of the new words at the insertion position or a region peripheral thereto. The visually recognizable information can be at least one of, for example, a change of color, the display of a sign, and the display of a symbol at the insertion position or the region peripheral thereto.

Furthermore, the display execution block 104 can provide (or display) a candidate suggestion window, including a plurality of candidate phrases having different syllable arrangements, to (or in) the touch panel in response to a control instruction from the new syllable addition processor 1083. Accordingly, the user can select any one of the plurality of candidate phrases within the candidate suggestion window and add the new words to the selected phrase. As a result, users can add new syllables more rapidly. Here, the user can dismiss the candidate suggestion window and return to the basic screen of the touch panel to perform modification (i.e., adding new words) can be performed by touching another region of the touch panel.

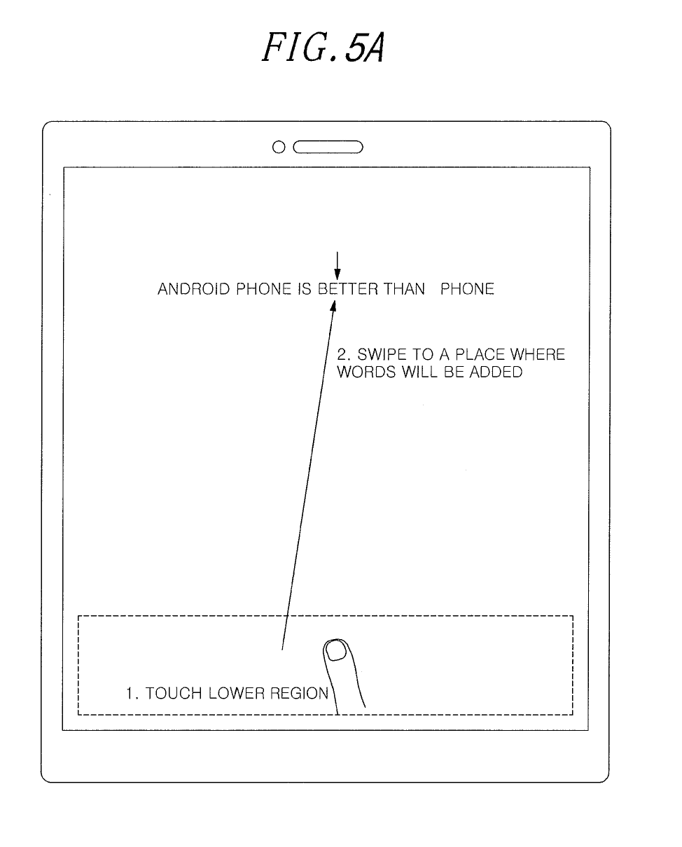

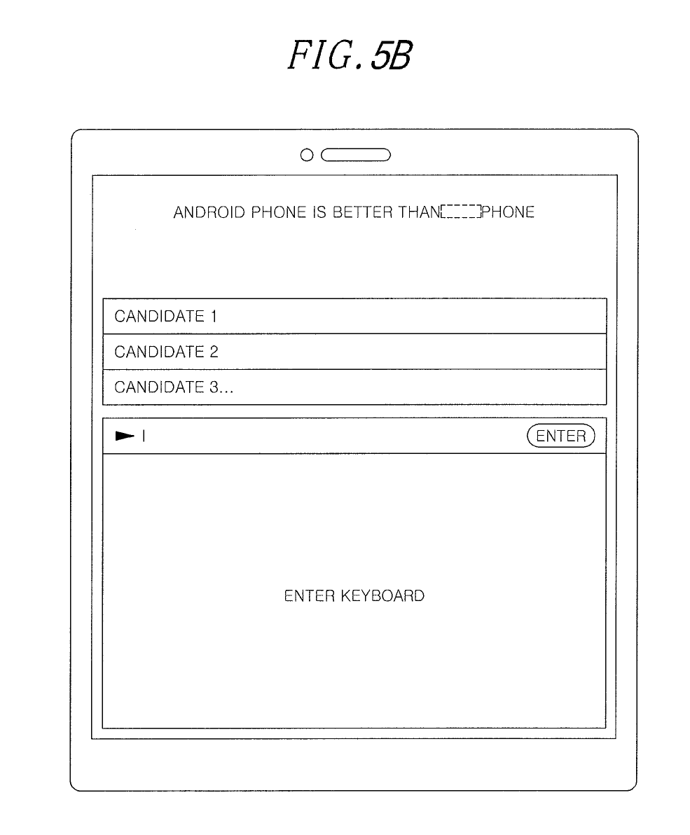

FIGS. 5a and 5b are exemplary diagrams of a syllable addition screen for illustrating the process of adding new words in accordance with the present invention. The exemplary diagrams show that new words intended by a user are added through the new syllable addition interaction using a touch by a finger and the screen keyboard in accordance with the present invention.

At step 220, the input analysis block 106 checks whether or not the received touch interaction corresponds to a touch for removing a designated syllable. If, as a result of the check, it is confirmed that the received touch interaction corresponds to a touch for removing a designated syllable, for example, if the received touch interaction is a syllable removal interaction in which a target syllable to be removed is touched by a finger and the touched finer is dragged to the top or bottom of the touch panel at high speed, the designated syllable removal processor 1084 performs control for removing the target syllable in response to corresponding touch interaction signals from the input analysis block 106. Accordingly, the display execution block 104 removes (or marks and deletes) the target syllable touched by the finger at step 222.

Here, the display execution block 104 can display visually recognizable information for making the user aware of the execution of the removal of the target syllable in the target syllable being edited or a region peripheral thereto. The visually recognizable information can be at least one of, for example, a change of color, the display of a sign, and the display of a symbol for the target syllable or the region peripheral thereto. The user can complete the designated syllable removal task by releasing the touch of the finger from the screen.

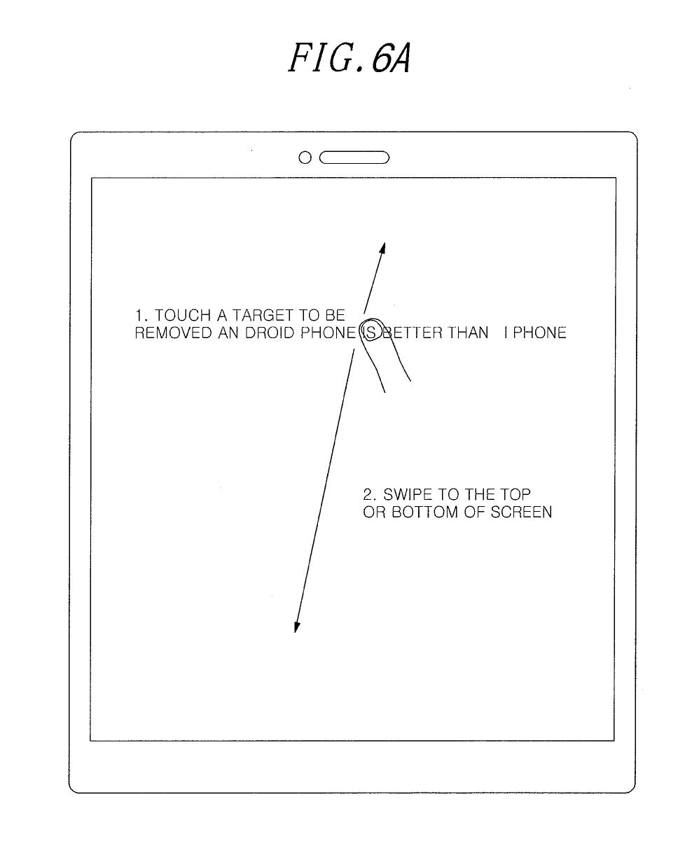

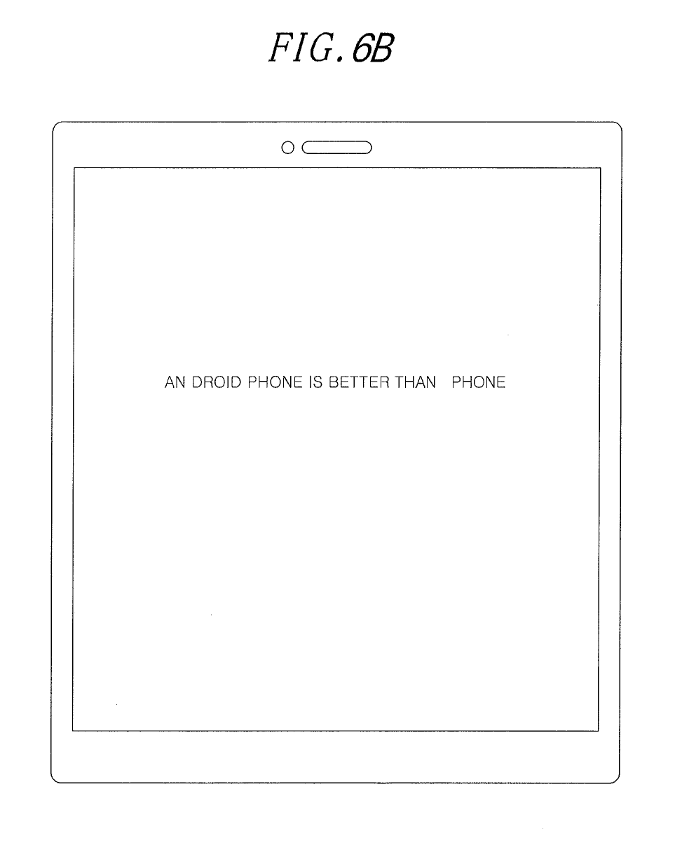

FIGS. 6a and 6b are exemplary diagrams of a syllable removal screen for illustrating the process of removing designated syllables in accordance with the present invention. The exemplary diagrams show that a target syllable not wanted by a user is removed from a sentence through the syllable removal interaction using a touch by a finger in accordance with the present invention.

At step 224, the input analysis block 106 checks whether or not the received touch interaction corresponds to a touch for changing the position of syllables. If, as a result of the check, it is confirmed that the received touch interaction corresponds to a touch for changing the position of syllables, for example, if the received touch interaction is a syllable sequence change interaction in which a target syllable whose position will be changed is touched by a finger and the touched finger is dragged to a desired destination position (e.g., left or right) at high speed, the syllable sequence change processor 1085 performs control for changing the position of the target syllable in response to corresponding touch interaction signals from the input analysis block 106. Accordingly, the display execution block 104 changes the position of the target syllable touched by the finger (i.e. the position of syllables) at step 226.

Here, the display execution block 104 can display visually recognizable information for making the user aware of the execution of a change in the sequence of the target syllable in the target syllable or a region peripheral thereto. The visually recognizable information can be at least one of, for example, a change of color, the display of a sign, and the display of a symbol at the target syllable or the region peripheral thereto. The user can complete the syllable sequence change task by releasing the touch of the finger from the screen.

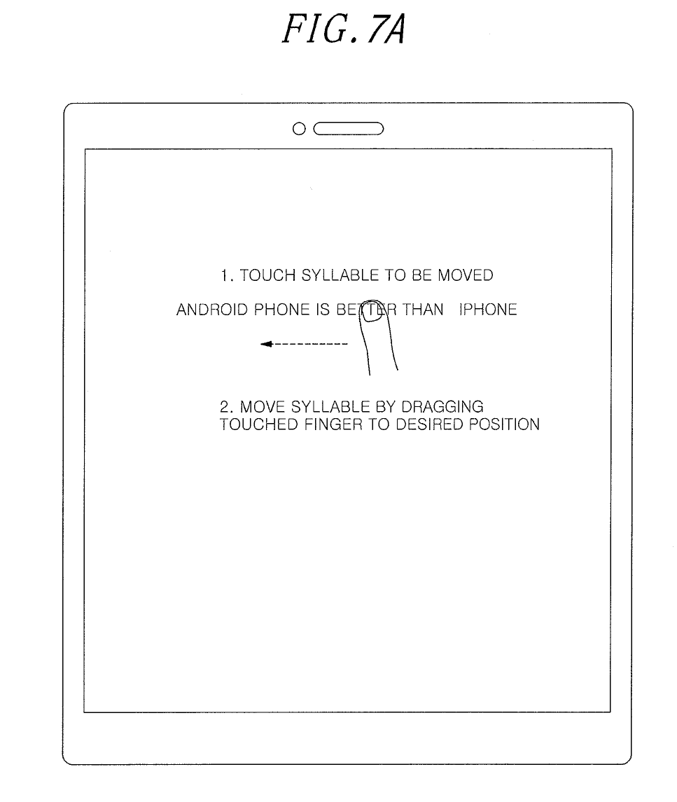

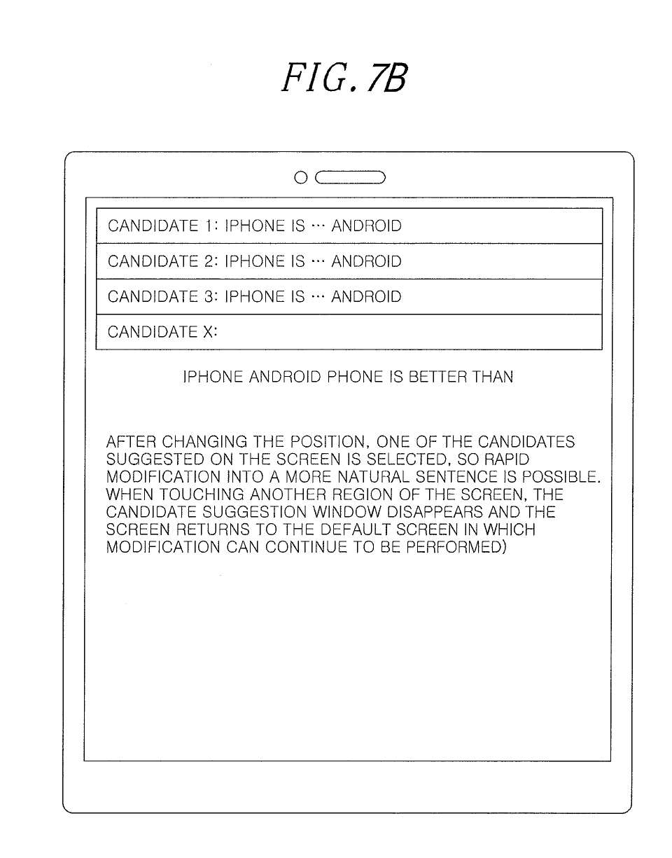

Furthermore, the display execution block 104 can provide (display) a candidate suggestion window (refer to the upper part of FIG. 7b), including a plurality of candidate phrases having different syllable arrangements, to (or in) the touch panel in response to a control instruction from the syllable sequence change processor 1085. Accordingly, the user can perform a task for selecting any one of the plurality of candidate phrases within the candidate suggestion window and changing the sequence of the target syllable in the selected phrase. Here, the user can dismiss the candidate suggestion window and return to the basic screen of the touch panel to perform modification (i.e., changing the sequence of syllables) by touching another region of the touch panel.

FIGS. 7a and 7b are exemplary diagrams of a syllable sequence change screen for illustrating the process of changing the position of syllables in accordance with the present invention. The exemplary diagrams show that the position of syllables of words described in a form unwanted by a user is changed through the syllable sequence change interaction using a touch by a finger in accordance with the present invention.

At step 228, the input analysis block 106 checks whether or not the received touch interaction corresponds to a touch for substituting or modifying the contents of a syllable. If, as a result of the check, it is confirmed that the received touch interaction corresponds to a touch for substituting or modifying the contents of a syllable, for example, if a target syllable is designated by a double touch or a touch using a relatively long finger, the screen keyboard is displayed in the touch panel, and an interaction for substituting or modifying the contents of the target syllable is received in response to a touch manipulation of a user, the syllable contents substitution or modification processor 1086 performs control for substituting or modifying the contents of the target syllable in response to corresponding touch interaction signals from the input analysis block 106. Accordingly, the display execution block 104 performs a task of substituting or modifying the contents of the target syllable in response to the input through the screen keyboard at step 230.

Here, the display execution block 104 can display visually recognizable information for making the user aware of the substitution or modification of the contents of the target syllable in the target syllable being edited or a region peripheral thereto. The visually recognizable information can be at least one of, for example, a change of color, the display of a sign, and the display of a symbol for the target syllable or the region peripheral thereto.

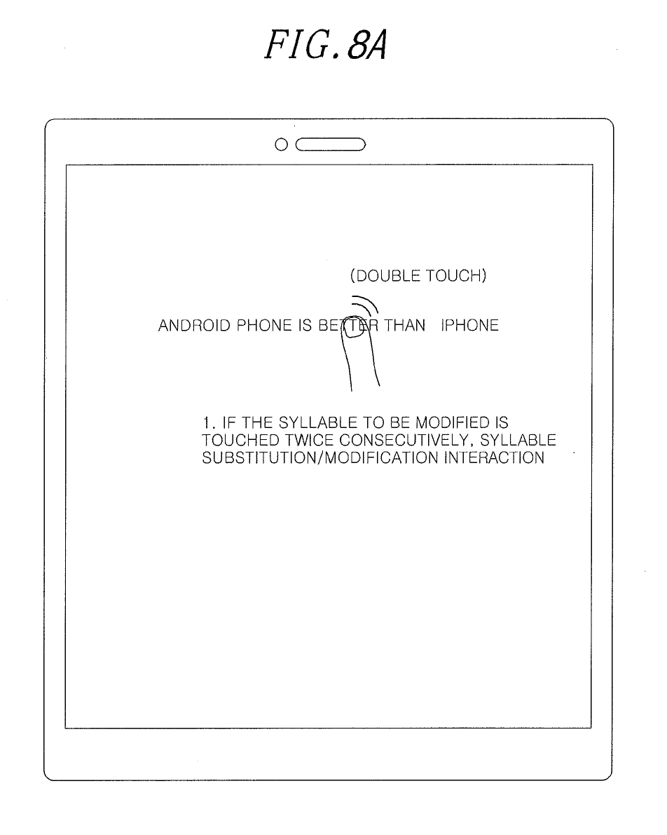

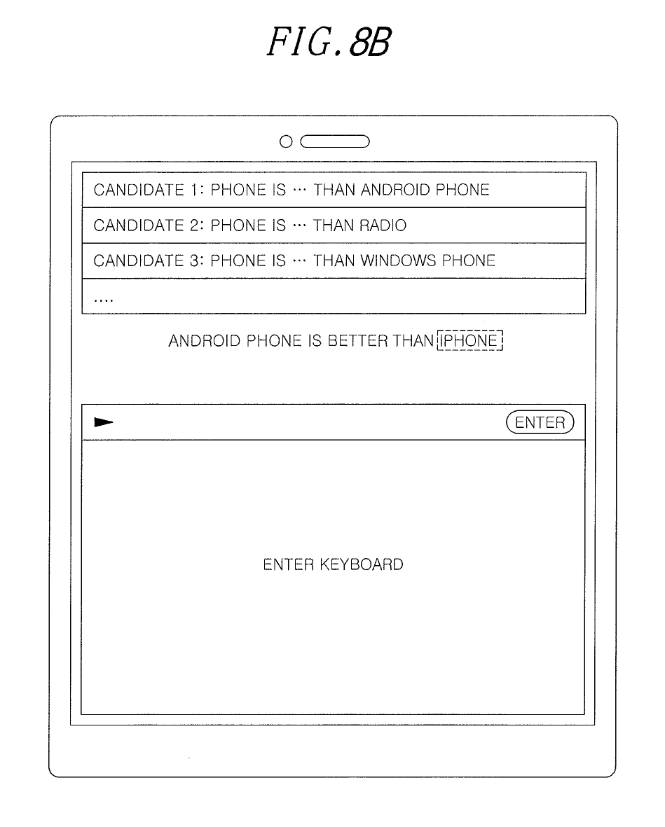

Furthermore, the display execution block 104 can provide (or display) a candidate suggestion window (refer to the upper part of FIG. 8b), including a plurality of candidate phrases having different syllable arrangements, to (or in) the touch panel in response to a control instruction from the syllable contents substitution or modification processor 1086. The user can perform a task for selecting any one of the plurality of candidate phrases within the candidate suggestion window and substituting or modifying the content of the target syllable. Here, the user can dismiss the candidate suggestion window and return to the basic screen of the touch panel to perform modification (i.e., substituting or modifying the content of a syllable) by touching another region of the touch panel.

FIGS. 8a and 8b are exemplary diagrams of a syllable contents substitution or modification screen for illustrating the process of substituting or modifying the contents of syllables in accordance with the present invention. The exemplary diagrams show that a typographical error or an error resulting from erroneous recognition is substituted or modified through the syllable contents substitution or modification interaction using a touch by a finger and the screen keyboard in accordance with the present invention.

In accordance with the present invention, a user can easily edit voice recognition results (or text) in a portable device according to his or her intention. The editing procedure is performed based on a handling method for a specific error form that commonly appears in the results of general voice recognition systems. Accordingly, there are advantages in that the number of touches on a screen or the number of keypresses by a user can be significantly reduced and repetitive modification can be easily performed in a desired form.

Furthermore, in accordance with the present invention, a user can edit voice recognition results (or text) into a desired sentence through a simplified user interaction using a voice recognition result editing apparatus implemented in the form of an automatic interpretation app and installed in a portable device. Accordingly, the quality of voice interpretation can be improved.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method for editing voice recognition results in a portable device, comprising:
a process of converting the voice recognition results into text and displaying the text in a touch panel;
a process of recognizing a touch interaction in the touch panel;
a process of analyzing an intent of execution of the recognized touch interaction; and
a process of editing contents of the text based on the analyzed intent of execution.

2. The method of claim 1, wherein the editing the contents of the text comprises any one of a merger of syllables, a separation of syllables, an addition of new words, a removal of a designated syllable, a change of a position of syllables, and a substitution or modification of syllable contents.

3. The method of claim 2, wherein the merger of syllables is executed through an interaction in which two syllables to be merged are touched by different fingers and a first touch of the two touches is dragged to a second touch of the two touches.

4. The method of claim 3, wherein a region in which the two syllables are displayed comprises visually recognizable information indicative of execution of the merger.

5. The method of claim 2, wherein the merger of syllables is executed through an interaction in which two syllables to be merged are touched by different fingers and dragged.

6. The method of claim 5, wherein a region in which the two syllables are displayed comprises visually recognizable information indicative of execution of the merger.

7. The method of claim 2, wherein the separation of syllables is executed through an interaction in which a target syllable to be separated is touched by a finger, a direction in which the target syllable is to be separated is touched by another finger, and the two fingers are dragged in the direction.

8. The method of claim 7, wherein a region in which the target syllable is displayed comprises visually recognizable information indicative of execution of the separation.

9. The method of claim 2, wherein the addition of new words is executed by:
a process of designating a position at which new words will be inserted by touching a predetermined syllable addition region within the touch panel using a finger;
a process of displaying a screen keyboard for entering the new words in a specific region of the touch panel when the insertion position is designated; and
a process of adding the new words entered through the screen keyboard at the insertion position.

10. The method of claim 9, wherein a region in which the insertion position is displayed comprises visually recognizable information indicative of execution of the addition.

11. The method of claim 2, wherein the removal of a designated syllable is executed through an interaction in which a target syllable to be removed is touched by a finger and the touched finger is dragged to a top or bottom of the touch panel.

12. The method of claim 11, wherein a region in which the touched target syllable is displayed comprises visually recognizable information indicative of execution of the removal.

13. The method of claim 2, wherein the change of a position of syllables is executed through an interaction in which a target syllable whose position will be changed is touched by a finger and the touched finger is dragged to a desired position.

14. The method of claim 13, wherein the touched target syllable is moved to the dragged position.

15. The method of claim 2, wherein the substitution or modification of syllable contents is executed by:
a process of designating a target syllable by a double touch or a touch using a relatively long finger;
a process of displaying a screen keyboard for substituting or modifying the target syllable in a specific region of the touch panel when designating the target syllable; and
a process of substituting or modifying the target syllable in response to an input through the screen keyboard.

16. The method of claim 15, wherein a region in which the target syllable is displayed comprises visually recognizable information indicative of execution of the substitution or modification.

17. An apparatus for editing voice recognition results in a portable device, comprising:
a text generation block for recognizing voice received through a microphone and converting the voice into text;
a display execution block for displaying the converted text in a touch panel of a portable device;
an input analysis block for recognizing a touch interaction in the touch panel and analyzing an intent of execution of the recognized touch interaction; and
a text editing block for editing contents of the text displayed in the touch panel based on the analyzed intent of execution.

18. The apparatus of claim 17, wherein the text editing block comprises:
a syllable merger processor for merging two syllables through an interaction in which the two syllables are touched by respective fingers and dragged;
a syllable separation processor for separating a target syllable through an interaction in which the target syllable is touched by a finger, a direction in which the target syllable will be separated is touched by another finger, and the two fingers are dragged in the direction;
a new syllable addition processor for touching a predetermined syllable addition region within the touch panel, displaying a screen keyboard for entering new words in a specific region of the touch panel when a position into which the new words will be inserted is designated, and adding the new words entered through the screen keyboard at the insertion position;
a designated syllable removal processor for removing a target syllable through an interaction in which the target syllable is touched by a finger and the touched finger is dragged to a top or bottom of the touch panel;
a syllable sequence change processor for changing a sequence or position of a target syllable to a changed sequence or position through an interaction in which the target syllable is touched by a finger and the touched target syllable is dragged to the changed position; and
a syllable contents substitution or modification processor for displaying the screen keyboard for substituting or modifying a target syllable when the target syllable is designated by a double touch or a touch using a relatively long finger in a specific region of the touch panel and substituting or modifying the target syllable in response to an input through the screen keyboard.

19. The apparatus of claim 17, wherein the display execution block displays visually recognizable information indicative of the execution of editing in a target syllable or a region peripheral to the target syllable.

20. The apparatus of claim 19, wherein the visually recognizable information comprises at least one of a change of color, a display of a sign, and a display of a symbol for the target syllable or the region peripheral to the target syllable.
